(19) United States
(12) Patent Application Publication
(10) Pub. No.: US 2004/0196648 A1
(43) Pub. Date: Oct. 7, 2004

(54) Side scattering polymer light guide and method of manufacture

(76) Inventors: James Bruce Franklin, Camperdown (AU); Geoffrey Burton Smith, Epping (AU); Edmond Kenneth Joseph, Burleigh (AU)

Correspondence Address: Michael E Carmen, Dilworth & Barres, 333 Earle Ovington Boulevard, Uniondale, NY, 11553, US

(21) Appl. No.: 10/478,584

(22) PCT Filed: May 21, 2002
(86) PCT No.: PCT/AU02/00631

(30) Foreign Application Priority Data
May 22, 2001 (AU) PR 5188

(51) Int. Cl. F25D 27/00; G02B 5/02

(52) U.S. Cl. 362/92; 362/558

(57) ABSTRACT

A side scattering light guide (10) for emitting light comprises a substantially transparent polymer core (12) surrounded by a transparent or translucent polymer cladding (14). The core (12) includes a light scattering additive (20) arranged to scatter light within the core so that at least some of the light passes through the cladding (14) to be emitted from the light guide (10). The light scattering additive (20) yields a high ratio of forward to backward scattering and is preferably in the form of diffuser particles. The type, density, concentration and/or refractive index of the light scattering additive may be selected to achieve the desired side scattering characteristics. A method of manufacturing the side scattering light guide (10) is also disclosed.

### FIELD OF THE INVENTION

The present invention relates to polymer light guides. In particular, it relates to side scattering polymer light guides. The present invention also relates to methods of producing side scattering polymer light guides.

### BACKGROUND TO THE INVENTION

Refrigeration display cabinets are typically lit with the use of fluorescent tubes. One of the problems with this method of lighting is that it heats the contents of the cabinet resulting in the efficiency of such cabinets being decreased. Side scattering light guides provide a solution to this problem in that they enable a refrigerated cabinet to be lit without heating the cabinet to the same extent. While side scattering light guides are useful for lighting refrigerated cabinets they can also be used for numerous other applications. Improvements in the efficiency and effectiveness with which the side scattering light guides function is therefore desirable.

U.S. Pat. No. 5,067,831 in the name of Robbins et al describes the general concept of the side scattering light guides. Robbins discloses a polymer core which is encased within a transparent fluoropolymer cladding. Robbins relies on the leakage of light from the cladding with passage of light through the core.

Japanese Patent JP08-094862-A in the name of Kokai discloses a transparent core encased within a fluoro-rubber cladding. The fluoro rubber cladding contains particles such as activated carbon, silica, silica gel, alumina or molecular sieves, a zeolite-based absorbent, an ion exchange resin, magnesium oxide (which has a high reactivity towards halogens), calcium carbonate or silver sulphate, which are useful for trapping a halogen compound. By trapping halogen compounds the aforementioned particles stabilise the cladding against a decrease in transmission due to halogen compounds. However the concentration of the aforementioned particles is higher than the optimum level of effective light enhancement and the particles therefore contribute to opacity. Furthermore, the transparent core is a silicone liquid, which is less useful for flexible light pipe applications than a solid flexible polymer.

U.S. Pat. No. 4,422,719 in the name of Orcutt discloses a transparent semi-solid core which is encased within a tubular cladding. Orcutt discloses the following ways of providing side scattering capabilities:

(1) Scoring the surface of the cylindrical core with angular cuts or discontinuities. The cuts and discontinuities deflect light beams circumferentially outwardly of the tubular core. The inside of the tubular cladding is etched or otherwise treated chemically or mechanically to cause light striking the inner surface of the tubular cladding to diffuse.

(2) Introducing bubbles or foreign materials into the cylindrical core material while the cylindrical core is still molten.

(3) Introducing powder into the tubular cladding material. For example, titanium dioxide (TiO₂) is present in the cladding material -at levels in the order of 2-10%.

(4) Forming the tubular cladding from a material which has an index of refraction exceeding that of the cylindrical core.

In order to achieve sufficient side scattering, prior additives to the core all had excessive opacity so that light could not be transmitted for more than a small distance from the light source and light output and hence brightness would vary very strongly with distance. To achieve sufficient length of light transport, conventional additives would have to be added at such low concentrations that little scattered side light would emerge. In addition bubbles and other foreign materials are often difficult to add uniformly into the core.

U.S. Pat. No. 6,091,878 in the name of Rohm and Haas Company limits the concentration of additives which are added to the tubular cladding to increase the effectiveness with which light is transmitted circumferentially out of a cylindrical light guide.

While Rohm and Haas Company addresses some of the deficiencies of Orcutt, the light guides of Rohm and Haas Company suffer from a lack of efficiency due to the large angles at which light is scattered by the aforementioned additive. The light guides of Rohm and Haas Company along with those of Orcutt also require additional manufacturing steps for their formation. For example, one of the methods of Orcutt requires the formation of angular cuts or discontinuities and the light guides of Rohm and Haas Company require the introduction of additives into the tubular cladding.

It is therefore desirable to provide an alternative side scattering light guide to those disclosed in the above-referenced patents. It is also desirable to provide an effective method of manufacturing such an alternative side scattering light guide.

### SUMMARY OF THE INVENTION

In one form, although it need not be the only or indeed the broadest form, the invention resides in a side scattering light guide for emission of light comprising:

a substantially transparent polymer core; and

a transparent or translucent polymer cladding surrounding said core; wherein

said core includes a light scattering additive arranged to scatter light within said core so that at least some of said light passes through said cladding to be emitted from said light guide

In a further form the invention resides in a method of manufacturing a polymer light guide including the steps of

producing a monomeric mixture from amounts of monomer, initiator and cross linking agents;

adding a light scattering additive to said monomeric mixture;

filling a polymer tube with the monomeric mixture; and

pressurising and heating a full length of the polymer tube to conditions appropriate to initiate and maintain polymerisation of the mixture.

Additional optional or preferable steps of the method of the specification of commonly-owned Granted Australian Complete Patent No. 736582 having a priority date of 18 May 1998 are hereby incorporated by reference into the present specification as additional optional or preferable steps of the method of the present invention.

The light scattering additive preferably comprises diffuser particles. The light scattering additive is preferably transparent. The light scattering additive is preferably made from a polymer and may be a cross-linked polymer. Preferably, the light scattering additive yields a high ratio of forward to backward scattering of the light.

Non-polymeric transparent particles could also be used as the light scattering additive.

The light scattering additive is preferably added to the monomeric mixture. The concentration of the light scattering additive is selected to achieve the desired side scattering light output over a desired length. A further embodiment of the present invention is to vary the concentration of the light scattering additive over the length of the light guide to achieve a desired light output profile.

The light scattering additive described in this invention may be added to the monomeric mixture in various forms including but not limited to; loose particles, particles in liquid suspension, particles encased in a polymer matrix that are not dissolved by the monomeric mixture such as injection moulded beads, pellets, sheets or rods.

The size of the diffuser particles is preferably between about 10 nanometres and about 200 micrometres. In a particularly preferred embodiment of the invention the size of the particles is between about 5 micrometres and about 50 micrometres.

In an alternative embodiment, the light scattering additive comprises a liquid immiscible with the monomeric mixture used to produce the polymer core.

The light scattering additive is preferably selected so that their refractive index is close to the refractive index of the polymerised core.

The density of the light scattering additive is preferably selected so that it is close or equal to the density of the monomeric mixture.

The concentration of the light scattering additive in the monomeric mixture may be varied in accordance with the required scattering length.

The side scattering light guide may be flexible and the flexibility may vary along the length of the light guide.

The side scattering light guide may be sheathed within a transparent or translucent sheath.

The side scattering light guide may be coupled to a standard light guide wherein the standard light guide transmits light to the side scattering light guide and the side scattering light guide emits said transmitted light out through the walls of the side scattering light guide.

The side scattering light guide may be coupled to a standard light guide by various techniques including transparent adhesives such as UV cured glue or optical epoxies.

### BRIEF DESCRIPTION OF THE DRAWINGS

The preferred embodiments of the present invention will now be described, by way of example only, with reference to the following figures in which;

FIG. 1 is a schematic longitudinal sectional view of an embodiment of the side scattering light guide showing the manner in which the light scattering additive scatters light;

FIG. 2 shows variable concentration of the light scattering additive along the length of the light guide;

FIG. 3 is a graph of light output versus distance from light source for light guides having different concentrations of light scattering additive;.

FIG. 4 is a schematic elevational view showing variable mixture production setup for variable scattering with length.

### BEST MODE FOR CARRYING OUT THE INVENTION

### LIGHT GUIDE EMBODIMENTS

Referring to FIG. 1, in one embodiment a light guide 10 generally comprises a polymer core 12, a polymer cladding 14 and a polymer jacket 16. The polymer cladding 14 encases the polymer core 12 and the polymer jacket 16 encases the tubular polymeric cladding 14. The polymer jacket 16 is a clear protective layer. For some applications the polymer jacket 16 is omitted from the light guide 10.

The cylindrical polymer core 12 is formed of a polymer matrix 18 which is impregnated with a light scattering additive in the form of diffuser s particles 20. In one embodiment the polymer matrix 18 is formed of Methyl Methacrylate (MMA) and the polymer cladding 14 is formed of poly-tetra-fluoro-ethylene (PTFE). The diffuser particles 20 may be formed of a cross-linked polymer, which is capable of being added to heated MMA without the diffuser particles 20 dissolving. The cylindrical polymer core 12 is polymerised with the diffuser particles 20 in situ.

In another embodiment, the diffuser particles 20 are formed of cross-linked PMMA particles embedded within a polymer matrix 18 made from a mixture consisting primarily of MMA and CR 39.

In standard light guides (i.e. as opposed to side scattering light guides) light is located within a polymer core and hence constrained to travel along the length of the polymer core by the low refractive index boundary between said polymer core and its surroundings. This low refractive index medium may consist of air, a tightly bound low refractive index cladding, or a low refractive index coating. Any light travelling away from a longitudinal axis of the polymer core is deflected back towards the longitudinal axis by the low refractive index boundary. Contrastingly, referring to FIG. 1, in the case of side scattering light guides 10, some of the light which travels within the polymer core 12 and which is represented by arrows 22 is scattered by diffuser particles 20 so that it is incident upon the polymer cladding 14 at such an angle that it passes through the polymer cladding 14 represented by arrows 23 and subsequently travels outwardly from the light guide 10. Such passage of light through the polymer cladding 14 results in a certain amount of light which is within the polymer core 12 passing out of the light guide 10 in a side scattering manner. Other light 22 which is scattered by diffuser particles to produce light which is represented by arrows 24 is incident upon an inner surface of the polymer cladding 14 at such an angle that the light is reflected within the polymer core 12. The remaining light represented by arrows 25 is not scattered by diffuser particles and is incident upon an inner surface of the polymer cladding 14 at such an angle that the light is reflected within the polymer core 12.

By selecting the material of the diffuser particles 20 so that the refractive index of the diffuser particles 20 is close to the refractive index of the polymer matrix 18, light is scattered by the diffuser particles 20 in a predominantly forward direction. The concentration of diffuser particles 20 can then be selected to provide the appropriate degree of side scattering. As the amount of side scattering increases, the effective useful working length of the side scattering fibre decreases due to a decrease in the amount of light which is transmitted along the fibre with an increase in distance from the light source. For a high concentration of diffuser particles 20, the effective useful working length is only a few centimetres whereas for a low concentration of diffuser particles 20, the effective useful working length is several metres.

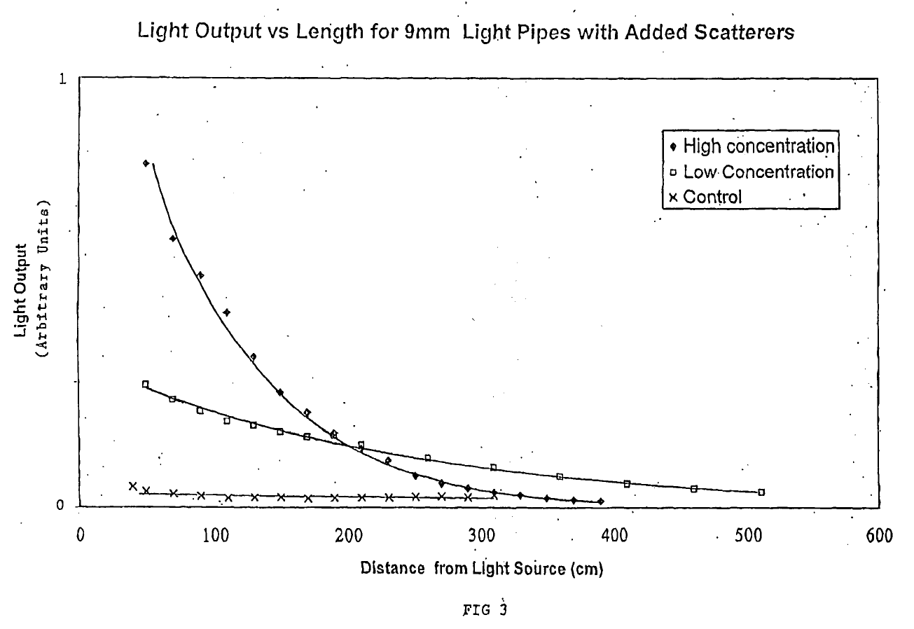

The variation of light output from a side scattering light guide 10 for different concentrations of diffuser particles 20 is shown in FIG. 3. The light output is measured for three separate light guides, each light guide having a different concentration of diffuser particles 20. The light output of said light guides is measured at specified positions along the length of the light guides. The distances of these positions from the relevant light source is recorded in centimetres.

The graph of FIG. 3 therefore consists of three separate plots which correspond to the three separate light guides having three different concentrations of diffuser particle 20.

The light output of each of the aforementioned light guides which are used to produce the plots of the graph of FIG. 3 were measured by illuminating one end of each of the three light guides with a metal halide lamp after using a dichoric filter to select the desired colour, which in the case of the plots of the graph of FIG. 3 was orange. The part of the light guide being measured at any given instance was measured by placing it along the axis of a 200 mm diameter integrating sphere and subsequently measuring the sphere's output with a photodiode. The integrating sphere averages all light emitted over the 200 mm length of the light guide which passes through it The light output measurements recorded for each of the points plotted on the graph of FIG. 3 therefore represent the total light emitted over a 200 mm length of the measured light guide One of the light guides which is represented in the graph of FIG. 3 was used as a control and was made by Poly Optics™ methods for manufacturing standard light guides (i.e. as opposed to side scattering light guides). The second of the three light guides included a low concentration of diffuser particles and the third of the three light guides included a high concentration of diffuser particles. The high concentration light guide has a diffuser particle concentration about ten times greater than the low concentration light guide.

Referring to the graph of FIG. 3, the light output from the high diffuser particle concentration light guide is initially much greater than that of the low diffuser particle concentration light guide. However, the light output of the high concentration light guide decreases much more rapidly than that of the low concentration light guide. Both light guides show an essentially exponential decrease of light output with distance.

Specifically, at a distance of 50 centimetres from the light source, the light output from the high concentration light guide is 2.88 times that of the low concentration light guide. However, at a distance of 310 centimetres from the light source, the light output of the high concentration light guide has fallen by a factor of 22.1 while that of the low concentration light guide has only fallen by a factor of 3.00. So at this distance, the output of the low concentration light guide is 2.54 times that of the high concentration light guide.

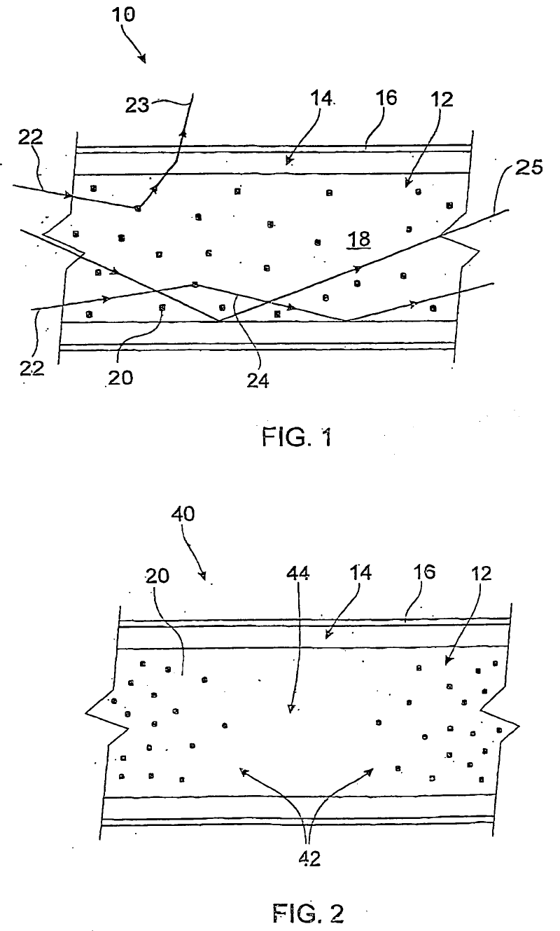

By varying the concentration of the particles along the length of the light guide, the desired light scattering profile may be achieved. A further embodiment, namely light guide 40 of FIG. 2 utilises this principle. In describing the features of the light guide 40, like features of FIGS. 1 and 2 are referred to by common reference numerals. The light guide 40 includes a polymer core 12, polymer cladding 14 and the optional polymer jacket 16 as described above in relation to FIG. 1. The light guide 40 differs however from the light guide 10 of FIG. 1 in that the concentration of diffuser particles 20 varies along the length of the polymer core 12. In the longitudinal segment of the light guide 40 which is shown in FIG. 2, the diffuser particles 20 vary in concentration over regions 42 and are not present in region 44. Light travelling within the polymer core 12 is scattered when it comes into contact with regions 42, and passes through the regions 44 without being scattered.

In a particularly preferred embodiment, the concentration of diffuser particles 20 is increased along the length of regions 42 in a way that ensures an essentially uniform light output from a given region 42. FIG. 3 shows that a uniform diffuser particle 20 concentration leads to an exponential decrease in light output along a side scattering light guide. Thus uniform light output may be achieved by exponentially increasing the diffuser particle 20 concentration along a light guide region 42. Other desired light output profiles may be achieved by appropriately manipulating the diffuser particle 20 concentrations along the light guide region 42.

The light guide 40 therefore functions as a side scattering light guide in longitudinal segments which correspond to regions 42, and as a standard (non-side scattering) light guide in longitudinal segments which correspond to region 44. The inclusion of regions 44 that lack diffuser particles is advantageous for some applications but may be omitted if desired.

Light guide 40 is useful for applications such as neon signs and refrigeration display cabinets where side scattering or illumination is only required along certain portions of the length of a light guide. For example, a single light guide corresponding to light guide 40 could be weaved through the internal space of a refrigeration display cabinet and the regions 42 which include the diffuser particles 20 could be appropriately positioned along the length of the side scattering light guide so that light is emitted from the light guide in longitudinal segments which extend along the sides and front of the refrigeration display cabinet, and not from the portions of the light guide which extend along the back of a refrigeration display cabinet. Side scattering light guides corresponding to light guides 40 can similarly be designed for neon sign applications by appropriately positioning scattering regions 42 along the length of a light guide, and by appropriately positioning each part of the length of the light guide so that the illuminated regions of the resulting light guide correspond to the required illuminated regions of the neon sign.

The light guide 40 is produced by modifying methods of producing light guides which are outlined in Granted Australian Complete Patent No. 736582. The description of the aforementioned Granted Australian Complete Patent relating to FIGS. 6-9 of that specification describes apparatus which is suitable for performing the method of that specification. Described below is a modification to the apparatus of Granted Australian Complete Patent No. 736582 which results in apparatus corresponding to the apparatus of FIGS. 6-9 of Granted Australian Complete Patent No. 736582 that are suitable for producing light guides corresponding to light guide 40 of the present specification.

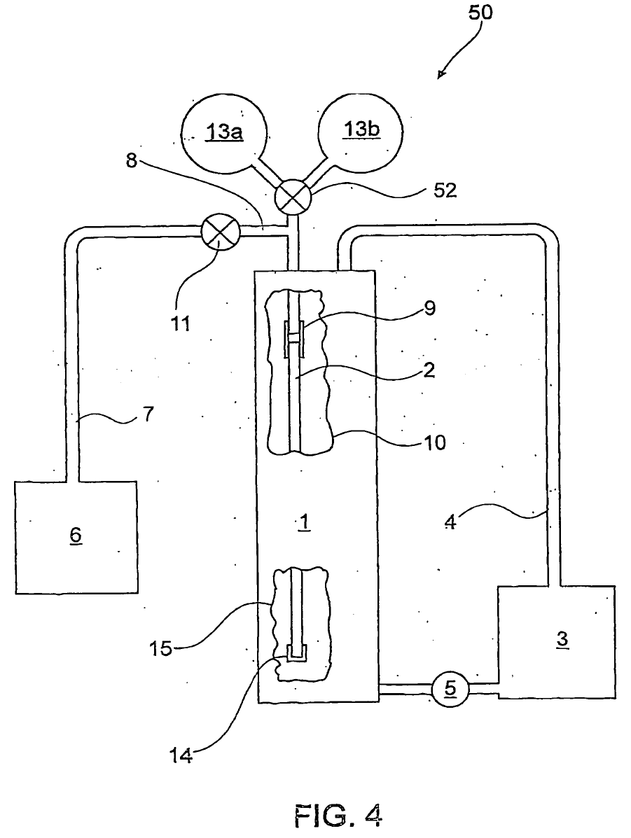

Referring to FIG. 4 of the present specification, one example of an apparatus 50 which is capable of producing the side scattering light guide 40 of FIG. 2 is identical to the apparatus of FIG. 6 of Granted Australian Complete Patent No. 736582 with the exception that two reservoirs 13a and 13b replace reservoir 13. Other reference numerals are identical to the other reference numerals of FIG. 6 of Granted Australian Complete Patent No. 736582. The apparatus 50 of FIG. 4 operates in the same manner in which the corresponding apparatus of FIG. 6 of Granted Australian Complete Patent No. 736582 operates with the exception that two separate monomeric mixtures, namely those contained within reservoirs 13a and 13b can both contribute to the polymer which is formed in tube 2. Granted Australian Complete Patent No. 736582 should therefore be referred to for details of the operation of the apparatus 50, which is common to the operation of the apparatus of FIGS. 6 of the aforementioned Granted Australian Complete Patent No. 736582.

The mixing unit 52 of the apparatus 50 is different to the tap 12 of the corresponding apparatus of FIG. 6 of the Granted Australian Complete Patent No. 736582 in that it allows the composition of monomeric mixture entering tube 2 to be varied from 100% from reservoir 13a to 100% from reservoir 13b and any mixture there between.

For the purpose of producing a light guide corresponding to light guide 40 which has a varying concentration of diffuser particles 20 along its length, one of the reservoirs, for example reservoir 13a, contains a monomeric mixture that does not include diffuser particles 20, and the other reservoir, namely reservoir 13b, contains a monomeric mixture which includes a relatively high concentration of diffuser particles 20. For formation of a length of the light guide 40 which includes the diffuser particles 20, the mixing unit 52 is adjusted so that the flow rate of monomeric mixture from reservoir 13b relative to that from reservoir 13a is such that the appropriate concentration of diffuser particles 20 is present within the polymer core 12 that is contained within the tube 2 of the apparatus 50. Lengths of the light guide 40 which do not contain diffuser particles 20 and hence correspond to regions 44 of FIG. 2 are formed by adjusting the tap 12 so that monomeric mixture from reservoir 13b is prevented from entering the tube 2. In light guides 40 made without non-scattering regions 44, the reservoir 13a may contain a low concentration of diffuser particles 20 rather than zero concentration.

The apparatus of FIGS. 7-9 of Granted Australian Complete Patent No. 736582 can be modified in a similar way by replacing each reservoir 13 with reservoirs 13a and 13b, in a similar manner to that described above in relation to FIG. 4 of the present specification to produce a corresponding apparatus which is suitable for formation of light guide 40.

Light guides of the various embodiments of the present invention can be formed from materials which result in light guides of varying flexibility ranging from a rigid rod to being highly flexible.

Another embodiment of the present invention relates to a light guide having a flexibility that varies along its length. Such a light guide can be produced using apparatus described above in relation to FIG. 4 of the present specification. Reservoirs 13a and 13b are filled with different monomeric mixtures that are capable of producing corresponding polymers of differing flexibilities. By appropriately adjusting the mixing unit 52 the relative portion of each of the monomeric mixtures from reservoirs 13a and 13b which contribute to polymer formed within the tube 2 can be varied to adjust the flexibility of the resulting polymer.

In order to form a standard light guide having a flexibility which varies along its length (as opposed to a side scattering light guide), reservoirs 13a and 13b are both filled with monomeric mixtures that do not contain diffuser beads 20. In order to form a light guide 10 of FIG. 1, having a flexibility which varies along its length, the monomeric mixture of both reservoirs 13a and 13b needs to include diffuser particles 20. However, in order to form a light guide 40 of FIG. 2, the monomeric mixture of one the reservoirs 13a or 13b must not include diffuser particles 20, or alternatively the concentration of diffuser particles 20 within monomeric mixture must be significantly less than the concentration of diffuser particles in the monomeric mixture of the other reservoir.

The material of the diffuser particles 20 may be selected so that their density is similar to or even the same as the density of the monomer solution, which is in turn polymerised to form the polymer matrix 18. Such selection ensures that settlement of the diffuser particles 20 during polymerisation of the polymer matrix 18 is minimised.

A reflector can be employed at an end of a light guide which is opposite the end which is illuminated to reflect light back and increase the brightness of that end of the light guide. The employment of a reflector also tends to improve the uniformity of the side scattered light. As an alternative, a light guide can be illuminated from both ends.

The side scattering light guide 40 may be coupled to a standard light guide wherein the standard light guide transmits light to the side scattering light guide and the side scattering light guide 40 emits the transmitted light out through the walls of the side scattering light guide. The side scattering light guide may be coupled to a standard light guide by various techniques including transparent adhesives such as UV cured glue or optical epoxies.

In another embodiment, the light scattering additive is in the form of a liquid that is immiscible with the monomeric mixture used to produce the polymer core. The immiscible liquid has a refractive index close to the refractive index of the polymer matrix 18 and the density of the immiscible liquid is close to that of the monomeric mixture. Once the core has polymerized, the immiscible liquid remains as a plurality of liquid droplets distributed within the core.

Methods of Forming the Light Guide Embodiments of the Present Invention

Formation of light guides that do not include diffuser particles. 20 within the polymer core 12 is detailed in Granted Australian Complete Patent No. 736582 having a priority date of 18 May 1998. Side scattering light guide embodiments of the present invention are formed by appropriately modifying the methods outlined in the “Detailed Description of the Drawings” section of the Granted Australian Complete Patent No. 736582. The methods outlined in the “Detailed description of the drawings” section of Granted Australian Complete Patent No. 736582 are hereby incorporated by reference to the present specification.

The modification involves the addition of diffuser particles 20 to the mixture of monomers, multi functional cross-linking agents, UV stabilisers/absorbers and initiators outlined in Granted Australian Complete Patent No. 736582. The monomers, multifunctional cross-linking agents and initiators are selected from the alternatives outlined in the “Detailed Description of the Drawings” section of Granted Australian Complete Patent No. 736582. The diffuser particles 20 are added to the aforementioned mixture.

Using this method the diffuser particles 20 are added to the polymer core 12 as part of the process of polymerising the mixture of monomers, multi functional cross-linking agents, UV stabilisers/absorbers and initiators. As previously mentioned, this is contrary to side scattering light guides referred to in the “Background of the Invention” section of the present specification.

### Applications

The side scattering light guides of the present invention are useful for, but not limited to the following applications.

(i) For lighting of refrigerated cabinets. As mentioned in the “Background to the Invention” section of the present specification side scattering light guides do not heat such cabinets as much as conventional lighting and as such do not have as much of an adverse effect on the efficiency and effectiveness of operation of a refrigeration cabinet.

(ii) With use of an LED or a lamp as a light source, side scattering light guides can be used to replace traditional building lighting.

(iii) Advertising.

(iv) Decorations including Christmas lighting.

(v) Safety lighting. The light source of a side scattering light guide of the present invention can be removed from the space which is being lit by the light guide.

(vi) Vehicle lighting including internal and external lighting.

(vii) Roadside lighting including lighting associated with roadside maintenance.

(viii) Temporary lighting, for example temporary barriers.

(ix) Guide or directional lighting.

(x) Applications which require a combination of end luminaire and side lighting.

(xi) Displays, monitor covers and projection screens.

(xii) Architectural and decorative feature lighting

(xiii) Neon tube replacement and neon sign replacement

(xiv) Distribution of daylight coupled into the light guide

(xv) Clothing, footwear and other apparel

Throughout the specification the aim has been to exemplify the invention without limitation to any particular combination of optional features on any single embodiment.

1. A side-scattering light guide comprising;
a transparent polymer core;
an optically transmitting polymer cladding surrounding said core and in contact with sides of said core, said cladding having a lower refractive index than a refractive index of said core, and
transparent diffuser particles distributed within said core, said diffuser particles having:
low back reflectance;
low absorbance;
a density close to the density of a monomeric mixture used to form said core; and
a refractive index close to the refractive index of said core;
wherein a concentration of said diffuser particles is arranged to scatter light within said core so that at least some of said light passes through said cladding to be emitted from said light guide.

2. The side scattering light guide of claim 1 wherein the diffuser particles yield a high ratio of forward to backward scattering of the light.

3. The side-scattering light guide of claim 1 wherein said diffuser particles are cross-linked polymer particles.

4. The side scattering light guide of claim 1 wherein said diffuser particles and said polymer core are formed from related polymer materials.

5. The side-scattering light guide of claim 4 wherein said diffuser particles and said polymer core are formed from methyl methacrylate.

6. The side scattering light guide of claim 1, wherein the diffuser particles are in the form of non-polymeric particles.

7. The side scattering light guide of claim 1, wherein the diffuser particles are in the form of particles encased in a polymer matrix that are not dissolved by a monomeric mixture used to produce the polymer core.

8. The side scattering light guide of claim 1, wherein the diffuser particles are in the form of injection moulded beads, pellets, sheets or rods.

9. The side-scattering light guide of claim 1 wherein the concentration of said diffuser particles is arranged to achieve a desired light output profile.

10. The side-scattering light guide of claim 1 wherein the concentration of said diffuser particles is arranged to achieve regions with higher side scattering of light and regions with lower side-scattering of light.

11. The side-scattering light guide of claim 10 wherein the regions with lower side-scattering of light have substantially no side scattering of light

12. The side scattering light guide of claim 1, wherein the concentration of the diffuser particles varies in accordance with a required scattering length.

13. The side-scattering light guide of claim 1 wherein the concentration of said diffuser particles increases exponentially along a length of said side-scattering light guide.

14. The side-scattering light guide of claim 1 wherein the concentration of said diffuser particles is varied to achieve substantially uniform side-scattering along a length of said side-scattering light guide.

15. The side-scattering light guide of claim 1, wherein the diffuser particles have a size between 0.01 micrometres and 200 micrometres.

16. The side-scattering light guide of claim 1, wherein the diffuser particles have a size between 5 micrometres and 50 micrometres

17. The side-scattering light guide of claim 1 wherein the density of the diffuser particles is equal to the density of the monomeric mixture used to form the core.

18. The side scattering light guide of claim 1, wherein the light guide is flexible.

19. The side scattering light guide of claim 18, wherein the flexibility varies along a length of the light guide.

20. The side scattering light guide of claim 1, wherein the light guide is rigid.

21. The side scattering light guide of claim 1 wherein the core is PMMA.

22. The side scattering light guide of claim 1 wherein the core is a ploymerised mixture of MMA and CR39.

23. The side scattering light guide of claim 1 wherein the optically transmitting polymer cladding is transparent.

24. The side scattering light guide of claim 1 wherein the optically transmitting polymer cladding is translucent.

25. The side scattering light guide of claim 1 wherein the optically transmitting polymer cladding is PTFE.

26. A method of manufacturing a side-scattering light guide, having a polymer core, by polymerisation casting including the steps of:
producing a monomeric mixture from at least monomer and initiator;
adding diffuser particles to said monomeric mixture, said diffuser particles having low back reflectance, low absorbance, a density close to the density of said core, and a refractive index dose to a refractive index of said core;
filling a low refractive index polymer moulding tube with the monomeric mixture containing the diffuser particles; and
pressurising and heating a full length of the polymer moulding tube to conditions appropriate to initiate and maintain polymerisation of the mixture, so that the final core material is a solid polymer containing controlled amounts and distributions of said diffuser particles.

27. The method of claim 26 wherein the step of producing a monomeric mixture includes adding multi-functional cross linking agents and/or UV stabilizers/absorbers.

28. The method of claim 26 wherein the diffuser particles yield a high ratio of forward to backward scattering of the light.

29. The method of claim 26, further including the step of selecting a concentration of the diffuser particles to achieve a desired side scattering light output over a desired length.

30. The method of claim 26, further including the step of varying a concentration of the diffuser particles over a length of the light guide to achieve a desired light output profile.

31. The method of claim 26, further including the step of exponentially increasing a concentration of the diffuser particles over a length of the light guide to achieve a substantially constant light output profile.

32. The method of claim 26 further including the step of varying a distribution of said diffuser particles so as to control a fraction of input light that is emitted at any point or zone along said light guide to provide design lighting levels.

33. The method of claim 26, wherein the diffuser particles are added to the monomeric mixture in the form of loose particles or particles in liquid suspension.

34. The method of claim 26, wherein the diffuser particles are added to the monomeric mixture in the form of particles that are not dissolved by the monomeric mixture.

35. The method of claim 26, wherein the diffuser particles are added to the monomeric mixture in the form of particles encased in a polymer matrix that are not dissolved by the monomeric mixture.

36. The method of claim 26 wherein the diffuser particles are added to the monomeric mixture in the form of injection moulded beads, pellets, sheets or rods.

37. The method of claim 26 wherein the diffuser particles are formed from drops of a liquid that is immiscible with the monomeric mixture used to form the core, and is transparent after the step of pressurizing and heating.

38. The method of claims 26 further including the steps of producing a first monomeric mixture with diffuser particles at a first concentration and a second monomeric mixture with diffuser particles at a second concentration, and wherein the step of filling includes varying an admixture of said first and second monomeric mixtures to vary a concentration of diffuser particles over a length of the light guide to achieve a desired light output profile.

39. The method of claim 38 wherein the second concentration of diffuser particles is zero.

40. A lighting display system comprising;
a side-scattering light guide comprising: a transparent polymer core; an optically transmitting polymer cladding surrounding said core and in contact with sides of said core, said cladding having a lower refractive index than a refractive index of said core; and transparent diffuser particles distributed within said core, said diffuser particles having: low back reflectance; low absorbance; a density close to the density of said core; and a refractive index dose to the refractive index of said core; wherein a concentration of said diffuser particles is arranged to scatter light within said core so that at least some of said light passes through said cladding to be emitted from said light guide; and a light source directing light into an end of said light guide.

41. The lighting display system of claim 40 further comprising a non-side-scattering light guide coupled to said side-scattering light guide.

42. The lighting display system of claim 40 wherein said concentration of diffuser particles in said side-scattering light guide are arranged to produce side scattering of light in regions of display and to minimize side scattering of light in other regions.

43. The lighting display system of claim 40 further comprising a light source at each end of said light guide directing light into each end of said light guide.

44. The lighting display system of claim 40 further comprising a reflector at an end of said light guide opposite to said light source.

45. The lighting display system of claim 40 wherein the concentration of said diffuser particles increases exponentially along the length of said side-scattering light guide.

46. A refrigeration display cabinet lighting system comprising: a side-scattering light guide comprising: a transparent polymer core; an optically transmitting polymer cladding surrounding said core and in contact with sides of said core, said cladding having a lower refractive index than a refractive index of said core; and transparent diffuser particles distributed within said core, said diffuser particles having: low back reflectance; low absorbance; a density close to the density of said core; and a refractive index close to the refractive index of said core; wherein a concentration of said diffuser particles is arranged to scatter light within said core so that at least some of said right passes through said cladding to be emitted from said light guide; and
a light source directing light into an end of said light guide:
wherein said light source is located external to said refrigeration display cabinet and said concentration of diffuser particles in said side-scattering light guide are arranged to produce side scattering of light in regions of display within said refrigeration cabinet and to minimize side scattering of light in other regions.

47. An apparatus for producing a side scattering light guide comprising:
at least one reservoir holding a monomeric mixture produced from at least a monomer, an initiator and transparent diffuser particles, said diffuser particles having:
low back reflectance;
low absorbance;
a density dose to the density of a monomeric mixture used to form said core;
a reaction vessel holding a low refractive index polymer tube fillable with said monomeric mixture;
pressure means connectable to the polymer tube for applying pressure to the tube before and after filling said tube with said monomeric mixture;
a temperature controlled fluid, circulable through the reaction vessel so as to control the temperature within the reaction vessel;
a pump for circulating the fluid; and
temperature control means for adjusting the temperature of the fluid.

48. The apparatus of claim 47 further comprising at least a second reservoir holding a monomeric mixture produced from at least a monomer, an initiator and diffuser particles at a different concentration to said first reservoir, and a mixing unit that allows the composition of the monomeric mixture in said tube to be varied between 100% of said monomeric mixture from said first reservoir to 100% of said monomeric mixture from said second reservoir.

49. The apparatus of claim 47 wherein said different concentration is zero.
